(19) United States
(12) Patent Application Publication
(10) Pub. No.: US 2003/0161041 A1
(43) Pub. Date: Aug. 28, 2003

(54) Safety spokes light reflector

(76) Inventor: Joseph S. Mooney, East Longmeadow, MA (US)

Correspondence Address: Joseph S. Mooney, 304 Millbrook Drive, East Longmeadow, MA, 01028, US

(21) Appl. No.: 10/082,617

(22) Filed: Feb. 25, 2002

(51) Int. Cl. G02B 5/12

(52) U.S. Cl. 359/523; 359/522

(57) ABSTRACT

A bicycle spoke reflector system that is easily attached to the individual spokes of a bicycle tire assembly is disclosed. The tubular spoke reflector members possess a reflective exterior surface and a longitudinal split to facilitate attachment to the spokes of the bicycle wheel. The tubular spoke reflector member is attached to the bicycle tire spokes by elastically spreading apart the longitudinal split in the spoke reflector member, by aligning the tubular member longitudinal split with the bicycle spoke and applying pressure to the side of the tubular member opposite the split. This allows insertion over and placement of the tubular member onto the individual spokes, relying on the elastic properties of the tubular member material to close around the bicycle spoke, and remain attached. The tubular spoke reflector member has an inside opening approximately equal to that of the bicycle spoke, and an exterior surface sufficiently large enough to provide substantial reflective surface area, yet not compromise the aerodynamics of the bicycle and bicycle tire assembly.

### BACKGROUND OF THE INVENTION

1. Field of the Invention

The present invention relates generally to a bicycle reflector system for use on spoked wheels such as the spoked wheels of bicycles and motorcycles.

2. Information Disclosure Statement

For both fitness and recreation, bicycling has seen increased popularity in recent years. As such an economical and efficient mode of transportation, our roadways are now more crowded with bicyclists than ever before. As more and more cyclists take to the roads, the need for better bicycle safety equipment becomes more important. The need for safer, more visible bicycles is heightened in periods of low natural light and diminished visibility, such as nighttime.

To this end, reflectors mounted on a bicycle serve to protect the bicycle enthusiast from oncoming motorists sharing the roadways, primarily during nighttime riding. Visibility of the cyclist is paramount, as the sooner the motorist sees the bicycle rider, the quicker the motorist can react and subsequently avoid the cyclist. Reflectors placed on the spokes of the bicycle wheels accentuate their light reflecting properties and visibility due to the rotation of the bicycle wheels.

Current bicycle reflectors are small, minimally reflective, relatively expensive, and time consuming to install, all serving to minimize their use of this important element of bicycle safety equipment.

It is therefore the aim of the present invention to provide a safer, more visible, less expensive, and easier to install bicycle spoke reflector system for today's bicycle enthusiast.

### OBJECTS AND SUMMARY OF THE INVENTION

It is one object of the proposed invention to present an improved bicycle spoke reflector system.

It is another object to provide a bicycle spoke reflector system that enables maximum visibility of the bicycle and rider when required.

It is yet another object to provide an inexpensive bicycle spoke reflector system.

It is a further object to provide a bicycle spoke reflector system that does not require a power source.

It is a further object to provide a method of attachment of the bicycle spoke reflector system to the bicycle spoke without the aid of hand tools.

A bicycle spoke reflector system that is easily attached to the individual spokes of a bicycle tire assembly is disclosed. The tubular spoke reflector members possess a reflective exterior surface and a longitudinal split to facilitate attachment to the spokes of the bicycle tire. The tubular spoke reflector member is attached to the bicycle tire spokes by elastically spreading apart the longitudinal split in the spoke reflector member, by aligning the tubular member longitudinal split with the bicycle spoke and applying pressure to the side of the tubular member opposite the split. This allows insertion over and placement of the tubular member onto the individual spokes, relying on the elastic properties of the tubular member material to close around the bicycle spoke, and remain attached. The tubular spoke reflector member has an inside opening approximately equal to that of the bicycle spoke, and an exterior surface sufficiently large enough to provide substantial reflective surface area, yet not compromise the aerodynamics of the bicycle and bicycle tire assembly.

The above, and other objects, features, and advantages of the present invention will become apparent from the following detailed description read in conjunction with the accompanying drawings. Items illustrated in different figures that have equivalent numbers are substantially identical.

### BRIEF DESCRIPTION OF THE DRAWINGS

FIG. 1 is a perspective view illustrating the preferred embodiment of the present invention.

FIG. 2a shows a side view of a bicycle with the present invention installed on all the spokes of each bicycle wheel.

FIG. 2b presents a detail view showing one wheel of a bicycle with the present invention installed on all spokes of the wheel.

FIG. 3 provides a cross sectional view taken generally along lines 2—2 of FIG. 2b, illustrating the sequential method of attachment of the present invention to the spoke of a bicycle wheel.

FIG. 4 exhibits an alternative embodiment of the present invention.

### DETAILED DESCRIPTION OF PREFERRED EMBODIMENTS

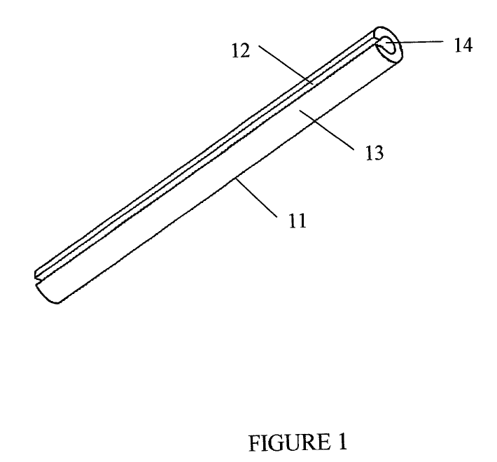

The present invention, illustrated in FIG. 1, consists of a tubular member 11, possessing a longitudinal split 12, along its entire length, having a length approximately equal to the length of a bicycle spoke, and possessing a reflective exterior surface 13. Further, the inside opening in the tubular member 14, has sufficient size to encompass the bicycle spoke 23; and the outside surface 13, of the tubular member sufficient surface area to provide maximum reflectivity.

The tubular member 11 may be fabricated from an inexpensive polymer extrusion, cut to the appropriate length, which can possess a reflective exterior 13, or any manufacturing process that can produce a structure of sufficient rigidity, elasticity, and reflectivity. The appropriate length of the tubular member would be determined by the size of the bicycle wheel, to ensure maximum reflective surface area. An alternative method of manufacture would be to over mold a material, possessing reflective properties, onto the individual spokes of the bicycle wheel, before installation onto the bicycle wheel 22.

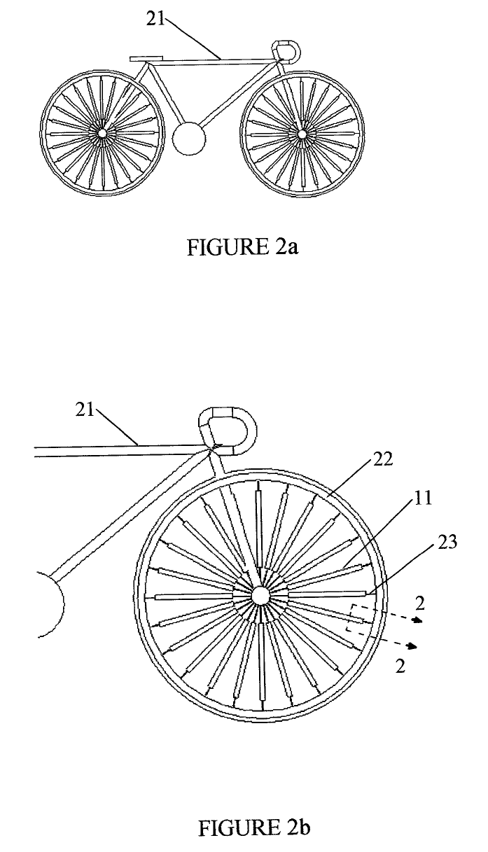

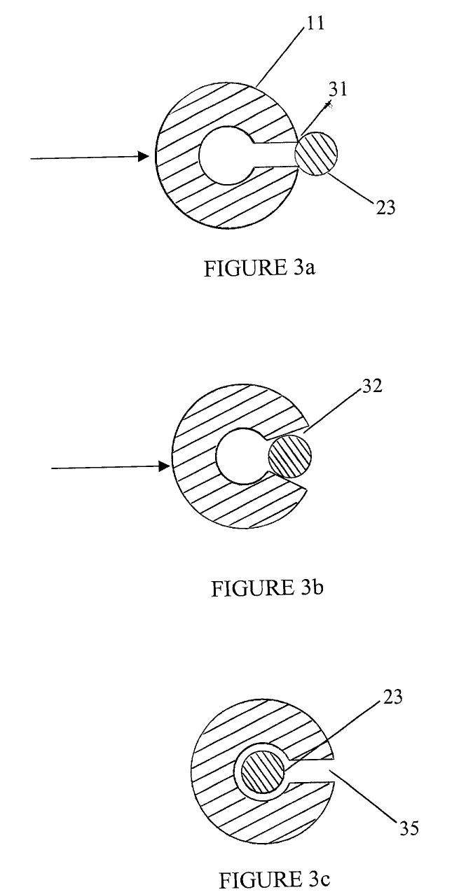

Referring to FIG. 2b, the present invention can be attached to the spokes 23, of a bicycle wheel 22, without the aid of any hand tools. Attachment of the present invention to the bicycle 21 is shown in FIG. 3. Attachment is achieved by aligning 31 the longitudinal split in the present invention with the spoke 23, of the bicycle, FIG. 3a.

The present invention is then manually pushed on the surface opposite the longitudinal split, in the radial direction towards the centerline axis of the bicycle spoke, resulting in an increased separation of the sidewalls of the longitudinal split, 32, in the present invention, as detailed in FIG. 3b. Once the present invention, 11 is positioned concentrically with the center axis of the spoke 23, the tubular member longitudinal split then returns to its original shape, encompassing the bicycle spoke, FIG. 3c. Relying on the inherent flexibility and memory of the tubular member material, the longitudinal split of the tubular member 11 will close back around the bicycle spoke 23, completing the installation. The longitudinal split 35, is of sufficient size so as to surround the spoke and remain attached to the bicycle wheel spoke. This installation can be repeated for some or all of the bicycle wheel spokes.

Improved reflectivity of the bicycle wheel is developed in the static condition due to the multitude of installed tubular members 11, all possessing reflective characteristics. Maximum reflectivity is achieved as the cyclist operates the bicycle, due to the dynamic effect presented by the rotation of the multitude of tubular members attached to the bicycle wheel spokes. The rotating bicycle wheel will appear to contain a solid reflector bordered by the rim and tire of the bicycle wheel when an external light source is present.

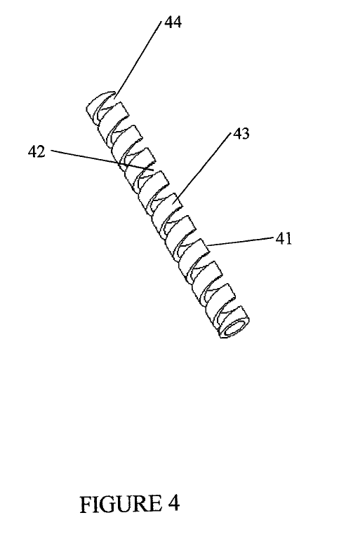

Referring to FIG. 4, an alternative embodiment of the present invention could be constructed from helical plastic jacketing material, similar to that used in the electronic wiring harness industry. The longitudinal split previously defined would be suitably replaced by that of a helical shaped split 42, wound about and traversing the central axis of the tubular member. One end 44 of the tubular member 41, could be inserted onto and rotated about the axis of the bicycle spoke until it entirely surrounds and covers the bicycle spoke. It would possess the same reflective exterior 43 properties as previously described.

Having described preferred embodiments of the invention with reference to the accompanying drawings, it is to be understood that the invention is not limited to these precise embodiments, and that various changes and modifications may be effected therein by one skilled in the art without departing from the scope or spirit of the invention as defined in the appended claims.

What is claimed is:

1. A bicycle spoke reflector system for use with a bicycle tire assembly, having spokes axially spaced around a central spindle and extending radially to a rim assembly, comprising:
at least one tubular member possessing a reflective exterior;
wherein said tubular member is positioned coaxially with said spoke.

2. A bicycle spoke reflector system for use with a bicycle tire assembly according to claim 1, wherein at least one said member possesses a longitudinal split along the entire length of said member.

3. A bicycle spoke reflector system for use with a bicycle tire assembly according to claim 2, wherein said tubular member has sufficient elastic properties to expand and retract about its longitudinal split to accept and surround said spoke.

4. A bicycle spoke reflector system for use with a bicycle tire assembly according to claim 1, wherein at least one said tubular member can be attached to said spokes of said bicycle tire assembly without the aid of hand tools.

5. A bicycle spoke reflector system for use with a bicycle tire assembly according to claim 1, wherein said tubular member does not require an external power source to function.

6. A bicycle spoke reflector system for use with a bicycle tire assembly according to claim 1, wherein said tubular member possesses a helical split, rotating about and traversing the entire length of said tubular member central axis.

7. A bicycle spoke reflector system for use with a bicycle tire assembly according to claim 6, wherein said tubular member has sufficient elastic properties so as to be able to wrap said member around said spoke by attaching one end of said tubular member to said spoke, and rotating said member about the central axis of said spoke until said member surrounds said spoke.
